(19) United States
(12) Patent Application Publication
(10) Pub. No.: US 2024/0399663 A1
(43) Pub. Date: Dec. 5, 2024

(54) HYBRID MANUFACTURING AND ELECTRONIC DEVICES MADE THEREBY

(71) Applicants: Nanyang Technological University, Singapore (SG); Panasonic Factory Solutions Asia Pacific Pte. Ltd., Singapore (SG)

(72) Inventors: Cheng Yang Nicholas THAM, Singapore (SG); Daryl Chin Yew LIM, Singapore (SG); Adam Zhe Kuan LIM, Singapore (SG); Lewei HE, Singapore (SG); Chidanand HEGDE, Singapore (SG); Mun Ji LOW, Singapore (SG); Murukeshan VADAKKE MATHAM, Singapore (SG)

(73) Assignees: Nanyang Technological University, Singapore (SG); Panasonic Factory Solutions Asia Pacific Pte. Ltd., Singapore (SG)

(21) Appl. No.: 18/690,885

(22) PCT Filed: Sep. 21, 2022
(86) PCT No.: PCT/SG2022/050680

§ 371 Date: Mar. 11, 2024

(30) Foreign Application Priority Data
Sep. 22, 2021 (SG) 10202110497X

(51) Int. Cl. B29C 64/30; B23K 26/24; B33Y 40/10

(52) U.S. Cl. CPC B29C 64/30; B23K 26/24; B33Y 40/10; B29K 2995/0005; B29K 2995/0092

(57) ABSTRACT

A hybrid manufacturing method and a device made thereby. The method includes: laser writing a border on a receiving surface of a substrate, the border defining an internal zone inside the border and an external zone outside the border, the border being a part of the substrate that is changed in its material properties by the laser writing; depositing a material in the internal zone, the material being deposited in an uncured state on the receiving surface, wherein a flow of the material from the internal zone towards the external zone is impeded by the border; and at least partially curing the material in the internal zone, the at least partially cured material forming a layer.

The present application claims priority to the Singapore patent application no. 10202110497X which is incorporated in its entirety by reference.

### TECHNICAL FIELD

The present disclosure relates to the field of additive and hybrid manufacturing, and more particularly to a method of hybrid manufacturing of electronic devices.

### BACKGROUND

Soft devices or devices are electronic devices that are, through design and material choices, stretchable and flexible, allowing these devices to conform better to non-planar surfaces. A challenge in soft electronics is the manufacturing of devices with suitable and compatible materials that maintains its functionality when deformed or stretched. Unfortunately, some materials with the desired elastomeric properties are traditionally difficult to use in additive manufacturing.

### SUMMARY

In one aspect, the present application discloses a hybrid manufacturing method. The method comprising: laser writing a border on a receiving surface of a substrate, the border defining an internal zone inside the border and an external zone outside the border, the border being a part of the substrate that is changed in its material properties by the laser writing; depositing a material in the internal zone, the material being deposited in an uncured or initially liquid state on the receiving surface, wherein a flow of the material from the internal zone towards the external zone is impeded by the border; and at least partially curing or otherwise at least partially modifying or solidifying the material in the internal zone, the at least partially cured, modified or solidified material forming a layer.

The border may define a perimeter of the layer. The border may comprise an impeding surface on the receiving surface, wherein the flow of the material across the impeding surface is slower than the flow of the material across the substrate or entirely stopped. The flow of the material may be impeded by the border for a delay time that is at least longer than a time to at least partially cure the material. The delay time may be at least longer than a time to deposit at least one subsequent layer on the layer and to at least partially cure the material. The border may be embedded in the substrate.

The substrate may comprise polyimide, and the laser writing may comprise forming laser-induced porous graphene as the border. The material may comprise polyimide. The material may comprise a non-thixotropic material. The material may comprise polydimethylsiloxane. The border may be oleophobic. The method may further comprise: using laser heating to form an interface area on the layer, the layer being hydrophobic, the interface area being non-hydrophobic properties; and depositing a hydrophilic material on the interface area. The hydrophilic material may comprise a conductive ink.

The method may further comprise: laser writing a subsequent border on the layer to define a subsequent internal zone; and depositing a subsequent material on the layer prior to a complete curing of the layer, the subsequent material being deposited in the subsequent internal zone to form a subsequent layer.

The method may further comprise additively fabricating a device, the method further comprising: laser writing a third border on the subsequent layer; and prior to a complete curing of the subsequent layer, depositing an uncured third material to form an encapsulating layer, wherein the encapsulating layer has a perimeter defined by the third border. The device may comprise a first layer and a second layer or multiple layers thereafter, the second layer and subsequent being deposited immediately adjacent to the first layer and prior layers prior to a complete curing of the first layer. The device may comprise at least one element embedded between the first layer and the second layer. At least one of the first layer and the second layer may comprise a non-thixotropic material. The at least one portion of the first layer comprises a modified material, the modified material comprising one or both of a hydrophobic and/or oleophobic material and a material compositionally different from the first layer, wherein the modified material is part of the at least one element and/or the border. The first layer and the second layer may be in crosslinking bond with one another such that the first layer and the second layer are indistinguishable from one another.

### BRIEF DESCRIPTION OF DRAWINGS

FIG. 1 is a schematic view of a hybrid manufacturing system according to an embodiment of the present disclosure;

FIG. 2 is a perspective view of a device in various stages of fabrication;

FIGS. 3A to 3G schematically illustrates the forming of a border according to embodiments of the present disclosure;

FIGS. 4A and 4B are schematic illustrations of the device with deposited materials;

FIG. 5 schematically illustrates a cross-sectional view of the device according to one embodiment;

FIGS. 6A and 6B schematically illustrate alternative embodiments of the device;

FIG. 7 is a perspective view of the device of FIG. 3A in a subsequent stage;

FIG. 8 is a perspective view of the device of FIG. 7 in a next stage;

FIGS. 9 to 11 are cross-sectional schematic diagrams illustrating methods of encapsulating the device of FIG. 8;

FIG. 12 is a flowchart of the hybrid manufacturing method according to one embodiment of the present disclosure; and

FIG. 13 is a flowchart of another embodiment of the method for hybrid manufacturing of a soft graphene electronic device.

### DETAILED DESCRIPTION

Reference throughout this specification to “one embodiment”, “another embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment. Furthermore, the described features, structures, or characteristics may be combined in any suitable manner in one or more embodiments. In the following description, numerous specific details are provided to give a thorough understanding of embodiments. One skilled in the relevant art will recognize that the various embodiments may be practiced without one or more of the specific details, or with other methods, components, materials, etc. In other instances, some or all known structures, materials, or operations may not be shown or described in detail to avoid obfuscation.

The word “exemplary” is used herein to mean “serving as an example, instance, or illustration.” Any embodiment described herein as “exemplary” is not necessarily to be construed as preferred or advantageous over other embodiments. As used herein, the singular ‘a’ and ‘an’ may be construed as including the plural “one or more” unless apparent from the context to be otherwise.

Terms such as “first” and “second” are used in the description and claims only for the sake of brevity and clarity, and do not necessarily imply a priority or order, unless required by the context. The terms “about” and “approximately” as applied to a stated numeric value encompasses the exact value and a reasonable variance as will be understood by one of ordinary skill in the art, and the terms “generally” and “substantially” are to be understood in a similar manner, unless otherwise specified.

In the present disclosure, the terms “additive manufacturing”, “3D printing”, and “net-shape manufacturing”, etc., may be used interchangeably in a manner generally understood in the art to refer to a process of joining materials to make articles based on 3D model data, by adding materials layer upon layer, as opposed to a subtractive manufacturing process. In the present disclosure, the term “hybrid manufacturing” and the like refers to a process combining elements of additive manufacturing, subtractive manufacturing, and/or any one or more methods of surface modification or material modification, in which at least one element of hybrid manufacturing involves making articles based on 3D model data.

The term “thixotropic material” refers to a material or mixture that exhibits thixotropy or a material which has a structural strength that decreases with a higher load (e.g., under a shearing load) and in which the structural-related property (e.g., viscosity) recovers completely after a certain rest period. In 3D printing, thixotropic materials that undergo a certain amount of shear while being dispensed/deposited will recover their pre-deposition viscosities such that the deposited materials can retain the generally intended shape. In contrast, the term “non-thixotropic material” as used herein generally refers to a material which has a structural strength that decreases under loading (e.g., shear forces) but in which the structural-related property (e.g., viscosity) does not fully recover to a pre-loading condition even after an appropriate rest period. The building of layer upon layer (e.g., in 3D printing) of such non-thixotropic materials remains challenging. The process of depositing the non-thixotropic materials via a nozzle generally subjects the materials to a certain degree of shearing load. Upon deposition, the non-thixotropic material generally remains in a state of low viscosity. In some cases, the deposited non-thixotropic material essentially flows and spreads out as in a liquid state such that the deposited material is unable to form a layer of the desired thickness. Other examples of non-thixotropic materials include but are not limited to various elastomers, such as silicones, silicone rubber materials, etc. In the following, various embodiments of the present disclosure are described using polydimethylsiloxane (PDMS) as an example of a non-thixotropic material to aid understanding, however, it will be understood that other thixotropic and/or non-thixotropic materials may be selected to form devices using the method described herein.

In the present disclosure, reference to an “uncured” state of a material may also refer to a liquid state of the material, including but not limited to a state in which the material is capable of flowing or spreading out when a droplet thereof is deposited on a surface. Reference to a material being in an uncured state may refer to the material being in an initially liquid state, e.g., before the material is subjected to curing or partial curing. The terms “curing” or “to cure” a material as used herein may generally refer to a process employed for toughening or hardening of a polymer material, for example, by the cross-linking of polymer chains. The terms “cured”, “fully cured” or “completely cured” generally refer to the polymer material being in a stable physical state wherein a further process of curing does not further toughen or harden the polymer. The terms “curing”, “cured”, “fully cured”, “completely cured”, etc., as used in the present disclosure do not limit the method of curing to any particular curing method. Examples of methods to fully cure or partially cure a material may include but are not limited to heating, laser irradiation, and/or various other physical or chemical methods.

The term “partially cured” as used herein refers generally to a state of a material in which the material is at least partially modified, at least partially made more viscous, at least partially hardened, and/or at least partially solidified. In the case where the material is a polymer, “partially cured” may correspond to a degree of cross-linking and/or hardening that is less than that of the same material in a fully cured state. A person of ordinary skill in the art would understand that a material is partially cured (i.e., not completely cured and not un-cured) if any one or more of the following is observed to be true: (i) the surface of the material is sticky or tacky (i.e., not fully cured), (ii) a layer of the material is able to mechanically hold the weight of a subsequent layer without visibly spreading out (“melting”) or collapsing; (iii) the material is able to bond fully with a subsequent layer. Additionally, or alternatively, a partially cured state may be ascertained by a flow test, e.g., the time taken by a given mass/weight of a droplet to overflow out of a pre-defined area. A material in a partially cured state may be observed to flow slower than the same material in a completely un-cured state. It will be understood that a fully cured material will not exhibit a flow of material.

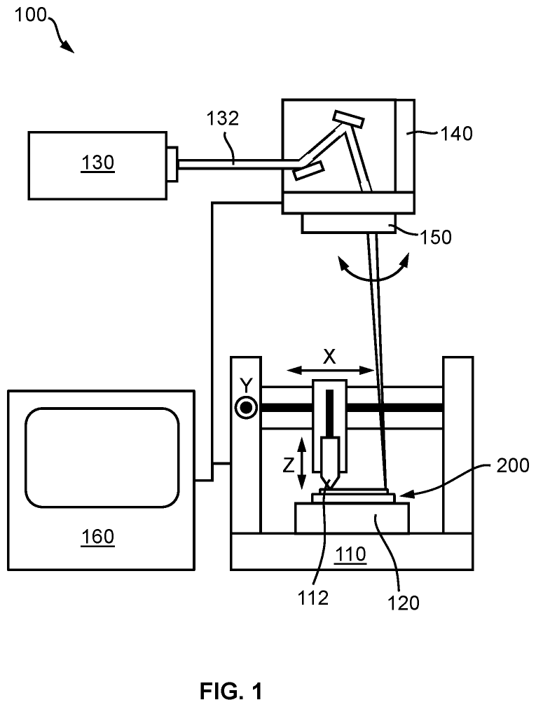

Disclosed herein is a method 700 of hybrid manufacturing and devices 200 made thereby. The method 700 may be used to produce an intermediate workpiece or a finished product. For the sake of brevity, in the present disclosure, the intermediate workpiece or the finished product is generally referred to as a device 200. The method 700 may be performed using one or more hybrid manufacturing apparatus. The system 100 of FIG. 1 is solely for illustration and other hybrid manufacturing set-ups may be used or modified for use to perform the method 700 of the present disclosure.

The system 100 may include a material dispenser 110 and a support 120. The system 100 may include a laser source 130 and a laser path controller, such as a Galvano scanner 140 with a swiveling or movable lens 150. The system 100 may include a controller 160 configured to individually or collectively control each of the material dispenser 110, the laser source 130, and the laser path controller, etc. The material dispenser 110 and the support 120 may be positioned or moved relative to one another. The support 120 may hold a substrate, and the system 100 may be configured such that a material deposited (also referred to as “extruded” or “dispensed”) by the material dispenser 110 may be deposited at a target location to form at least a part of the device 200. In some embodiments, the material dispenser 110 may include a nozzle 112 configured to be linearly displaceable relative to the support 120. In a non-limiting example, a three-dimensional coordinates frame of reference (e.g., X, Y, and Z-directions) may be used to define a path for the nozzle 112 (relative to the support 120) as the system 100 controllably dispenses or deposits the material to additively build at least a part of the device 200. In some embodiments, the material dispenser 110 may include a plurality of nozzles configured to respectively deposit multiple types of materials. In an example, one of the plurality of nozzles may be configured to deposit polydimethylsiloxane (PMDS) at a predetermined flow rate and another of the plurality of nozzles may be configured to deposit polyimide (PI) at another predetermined flow rate. In some embodiments, the respective flow rates of the nozzles may be dynamically controlled by the controller 160. The laser source 130 may be a carbon dioxide (CO₂) laser source or any other laser source configured to provide a laser output 132. The Galvano scanner 140 may include one or more movable mirrors configured to direct the laser output 132 to the device 200. In some embodiments, a F-theta lens 150 may be provided to focus and direct the laser output 132 on the support 120.

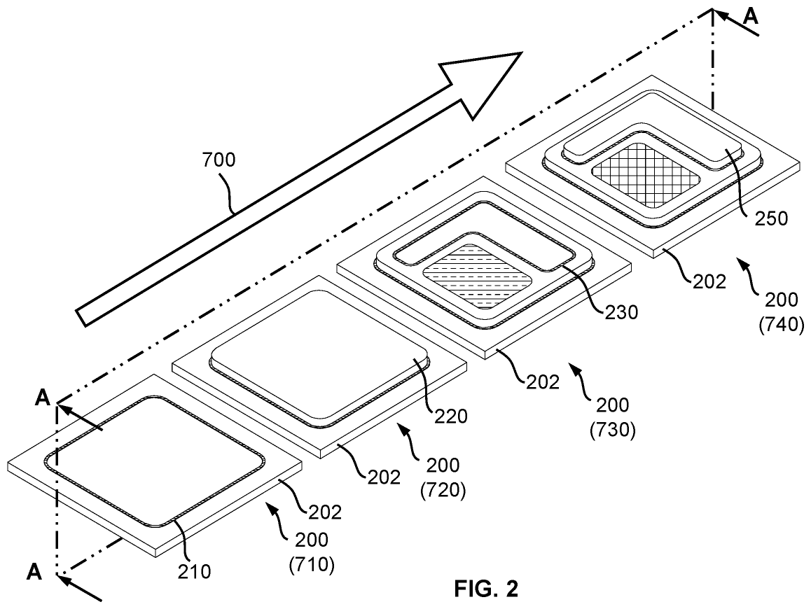

FIG. 2 schematically illustrates an example of a device 200 at various stages (710/720/730/740) of a method according to embodiments of the present disclosure. In this non-limiting example, the device 200 may be additively fabricated to progressively include one, two, or more layers of materials on a substrate 202. Advantageously, all stages (710/720/730/740) of the method can be performed using one hybrid manufacturing apparatus, such as the system 100 of FIG. 1.

The substrate selected for use may be formed from an elastic or flexible material, or from a non-elastomeric material such as a glass. Alternatively, the substrate 202 may include one or more layers of previously deposited materials. As will be understood from the present disclosure, materials traditionally deemed unsuitable for 3D printing (e.g., non-thixotropic materials) can be selected for use in the present method 700 as materials for the substrate or as materials for deposition. For the sake of illustration and not to be limiting, the following examples will be described with reference to a substrate of polyimide (PI). Examples of other polymers which may be selected as material for deposition include but are not limited to various elastomers, thermoplastics and thermoset materials, such as poly(m-phenylenediamine) isophthalamide, polyamide, Imide (PAI), polyether sulfone (PES), poly(paraphenylene terephthalamide), polybenzimidazole (PBI), polyether ether ketone (PEEK), polyphenylene sulfide (PPS), chlorinated poly(vinyl chloride) (CPVC), polystyrene (cross-linked), epoxy, phenolic resin, etc.

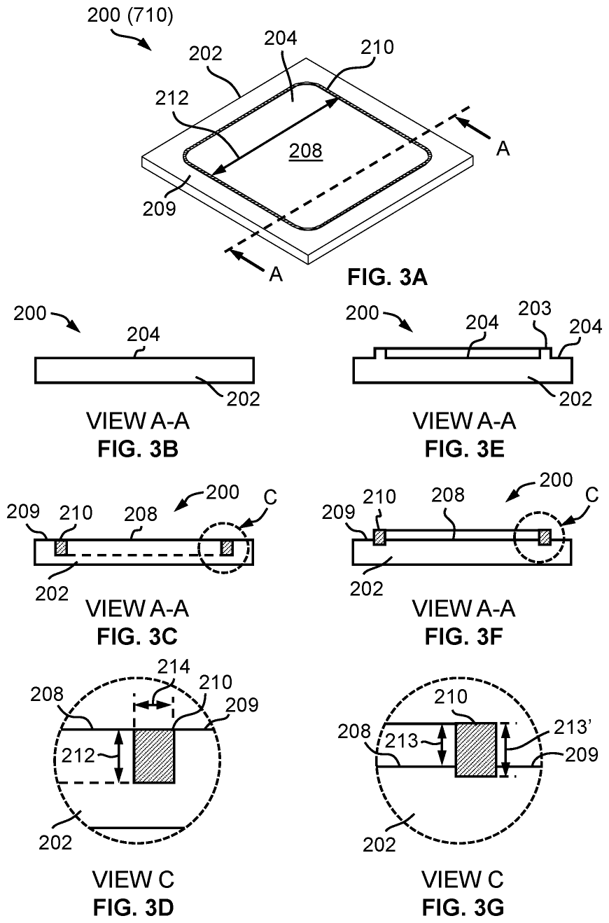

FIG. 3A is a perspective view of the device 200 at a stage 710 of border definition. The laser output 132 is used to perform direct laser writing on the substrate 202 such that a border 210 is defined on a receiving surface 204 of the substrate 202. The border 210 is preferably shaped as a closed path that partitions the receiving surface 204 into an internal zone 208 (within the border 210) and an external zone 209 (outside the internal zone 208). The external zone 209 includes the one or more parts of the receiving surface 204 that surrounds and/or is peripheral to the internal zone 208. In the non-limiting example of FIG. 3A, the border 210 is shaped as a quadrilateral loop. The shape and size (e.g., the length/breadth/diameter 212 as the case may be) of the border 210 may vary from example to example, depending on the specific application.

In some embodiments, the border 210 is formed by subjecting one or more parts of the substrate 202 to localized laser treatment under predetermined laser parameters, e.g., a predetermined temperature. The predetermined temperature is preferably a temperature sufficiently high to enable a local structural change in the material of the substrate 202. For example, for a substrate 202 of glass, the border 210 may be a zone of greater surface roughness resulting from laser ablation of the glass on the selected areas of the receiving surface 204. In another example, the predetermined temperature may be a temperature selected to result in a localized chemical composition change to the material of the substrate 202. For example, for a substrate 202 of polyimide, the border 210 may be made of porous graphene, in which the porous graphene is formed by subjecting selected parts of the polyimide to laser irradiation. In another example, for a substrate 202 of polydimethylsiloxane (PMDS), the border 210 may be a zone with a higher degree of hydrophobicity or a zone with more pronounced oleophobic properties as a result of laser irradiation. That is, the border 210 may be oleophobic. Preferably, the predetermined temperature is selected to be lower than a flashpoint of the substrate 202 to avoid combustion of the device 200.

Laser parameters for forming a border thereon may be selected from a range of operational parameters, i.e., an operation range of laser parameters. Table 1 below shows examples of operational ranges of the laser parameters solely for the purpose of illustration to aid understanding and not to be limiting. The operational range of the laser parameters may differ as a result of different material composition or laser source used, but one skilled in the art would be able to appreciate from these illustrative examples to set the laser parameters to correspond to a fraction of the energy requirements for completely curing the material.

TABLE 1
Parameters for Border Formation

| Material | PDMS | | Polyimide | |
|---|---|---|---|---|
| Hatch spacing | 80-120 | micrometers | 80-200 | micrometers |
| Laser intensity/power | 10%-20% | | 5%-35% | |
| Laser scan speed | 50-75 | mm/s | 50-100 | mm/s |
| Number of scan cycles | 1-5 | cycles | 1-2 | cycles |

The laser parameters may also be selected based on the amount of delay time desired. In some examples, for border formation on PDMS, laser intensity/power is set to 15% and laser scan speed is set at 55 mm/s. The corresponding delay time achievable can be as much as 10 minutes. In other examples, for border formation on polyimide, the laser power or laser intensity is preferably set to 35% and the laser scan speed is preferably set at 75 mm/s. Similarly, this corresponds to a delay time of as much as 10 minutes.

For comparison, FIG. 3B shows a schematic cross-sectional view of one embodiment of the device 200 of FIG. 3A at plane A-A, prior to creating the border 210. In this embodiment, the substrate 202 is a substantially planar article (i.e., the receiving surface 204 is substantially flat throughout) with a substantially uniform material composition (e.g., a first material).

FIG. 3C illustrates the device 200 of FIG. 3B, after the border 210 is created. The receiving surface 204 of FIG. 3B now includes an internal zone 208 demarcated by the border 210. The parts of the receiving surface 204 within the internal zone 208 may be substantially similar to the receiving surface 204 within the external zone 209, in terms of material composition, roughness, etc. The border 210 is of a second material that is different from the first material, i.e., different from the material of the internal surface 208 and the external surface 209, in which the second material is a product of laser irradiation of the first material. In other words, portions of the substrate 202 subjected to laser treatment may experience a structural change and/or a chemical compositional change as a result of localized laser irradiation, while the structure and/or chemical composition of other portions of the substrate 120 remain substantially unchanged. Alternatively described, the border 210 is provided with a microscopic structure and/or chemical composition that is different from the bulk material of the substrate 202.

FIG. 3D is a partial close-up view (view C) of the device 200 of FIG. 3C. The border 210 in different embodiments may have different dimensions, e.g., the depth/thickness dimensions 212 and the border widths 214 may vary from example to example. The dimensions 212/214 of the border 210 may be controllably determined by the laser parameters, e.g., the laser intensity, the duration of exposure to laser irradiation, the laser spot size, the number of laser scans along the border 210, etc. The border 210 is shown to be embedded in the substrate 202 such that the receiving surface 204 remains substantially flat. In actual implementation, there may be a slight protrusion or indentation of the border 210 within generally acceptable tolerances in the manufacturing of electronic devices.

FIG. 3E is a schematic cross-sectional view of another embodiment of the device 200 of FIG. 3A at plane A-A, prior to creating the border 210. In this embodiment, the substrate 202 includes features 203 of different elevations such that the receiving surface 204 is not flat throughout. In this non-limiting example, the features 203 and the rest of the substrate 202 are made from the same material, e.g., the first material.

FIG. 3F illustrates the device 200 of FIG. 3E, after a raised border 210 is created by selective or localized laser irradiation at the features 203. The receiving surface 204 of FIG. 3E is differentiated into a border 210, an internal surface 208 (within the border 210), and an external surface 209 (outside the border 210). Since the internal surface 208 and the external surface 209 were not subjected to laser treatment, these areas (receiving surfaces) retain their respective original properties, e.g., in terms of material composition, hydrophobicity, hardness, elasticity, etc.

FIG. 3G is a partial close-up view (view C) of the device 200 of FIG. 3F. The border 210 in different embodiments may have different dimensions. For example, the depth dimensions 213/213′ of the raised border 210 may be varied by controlling the laser parameters used for direct laser writing of the border 210. Examples of the laser parameters include but are not limited to the laser intensity, the duration of exposure to laser irradiation, the laser spot size, the number of laser scans along the border 210, etc.

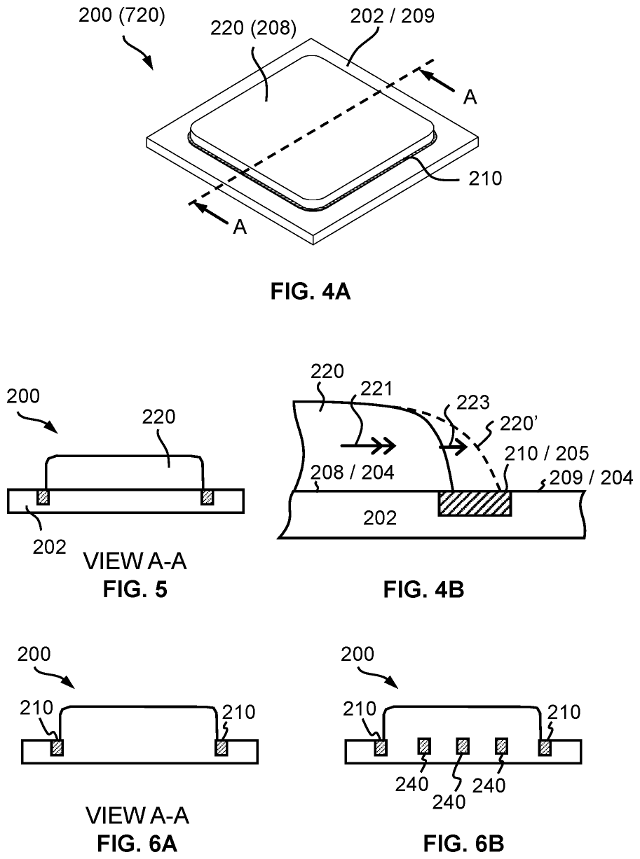

FIG. 4A is a schematic perspective view of the device at a stage 720 of material deposition. In this example, the substrate 202 is made of a first material (e.g., polyimide), and the border 210 is made of a second material (e.g., porous graphene), in which the second material is obtained by in-situ laser treatment of the first material. After the border 210 has been defined by laser irradiation on selected parts of the substrate 202, at least one material for one new layer may be deposited on the receiving surface 204. Depending on the final product to be formed, one or more materials may be deposited at the respective target locations on the substrate 202. In this example, more polyimide or PDMS (depending on the intended device to be formed) may be deposited at a target location generally in the internal zone 208. As illustrated in FIG. 4A, the newly added polyimide forms a new layer constrained by the border 210, thus taking on the shape defined by the border 210. In other words, the present method includes laser writing a border 210 on the receiving surface 204 of the substrate 202 such that the border 210 defines an internal zone 208 inside the border 210 and an external zone 209 outside the border 210. The border 210 is essentially a part of the substrate 202 that has been changed in its material properties by the laser writing. The method includes depositing a material in the internal zone 208. The material is deposited in an uncured state on the receiving surface 204. The flow of the material from the internal zone 204 towards the external zone 209 is impeded by the border 210. The method includes at least partially curing the material in the internal zone 208 such that the at least partially cured material forms a layer 220. The border 210 may define a perimeter of the layer 220.

FIG. 4B schematically illustrates a partial cross-sectional view of the device FIG. 4A at an instance when the newly deposited polyimide or PDMS (depending on the intended device to be formed) is flowing or is spread over the substrate 202. Even if the deposited material is a non-thixotropic material (in an uncured state) such that the material starts to flow away from the point of deposition, when the deposited material reaches the border 210, further flow of the deposited material is impeded or slowed down by the border 210. That is, the rate of flow 223 across the second material of the border 210 is configured to be slower than the rate of flow 221 of the same deposited material 220/220′ across the first material in the internal zone 208. In other words, even the flow of the non-thixotropic material can be retarded or interrupted by the border 210. That is, the border 210 may include an impeding surface 205 on the receiving surface, such that the flow of the material across the impeding surface 205 is slower than the flow of the material across the substrate 202.

According to embodiments of the present disclosure, the border 210 need not be configured as a non-permeable physical wall raised above the receiving surface 204. For example, the border 210 need not be a raised border (such as that illustrated in FIGS. 3F and 3G) in order to provide a retarding effect or an impeding effect on the rate of flow of the material. Advantageously, the border 210 (such as that illustrated in FIGS. 3C and 3D) may be embedded in the substrate 202, or present the impeding surface 205 substantially in-plane with the receiving surface 204 of the substrate 202, e.g., to minimize the overall thickness of the finished product, etc. In some examples, a border 210 may be laser-induced graphene or porous graphene that is substantially embedded in the substrate (e.g., FIG. 3D).

If the second material forming the border 210 is too porous, a certain amount of the deposited material may be infiltrated into the second material without impeding flow. This can be mitigated by forming the border 210 with different compositions such that the deposited material is sufficiently impeded even while infiltrating the material (the interface between the internal surface 208 and the impeding surface 205). Alternatively, the border 210 may be given a border width 214 that is relatively narrow such that there is sufficient impediment to constrain the flow of the deposited material while preventing too much infiltration of the deposited material into the second material. In the case where the second material is porous graphene, there may be some infiltration of the deposited material into the border 210 if the deposited material remains uncured while traversing the impeding surface 205. Nonetheless, experiments demonstrated that the border 210 can be provide sufficient impeding effects for building up a new layer of the deposited material.

The slower rate of flow of the non-thixotropic material at the border 210 provides a window of opportunity to cure the deposited material. Heating or curing may be carried out by directing a laser to the deposited material within the internal zone 208 (in contrast to the preceding stage where laser irradiation was directed to the border 210 and not to the internal zone 208). Depending on the relative differences in the microscopic structures and/or chemical composition of the impeding surface 205 of border 210 and the internal surface 208 of the substrate 202, the extent of impediment or (posed by the change from the first material to the second material) to a flow of the newly deposited material may vary from example to example. Preferably, the impeding surface 205 and the internal surface 208 are selected or configured such that an uncured non-thixotropic material flowing from the internal zone 208 towards the external zone 209 will be sufficiently impeded by the impeding surface 205. For the present purpose, the impediment posed by the border 210 is considered sufficient if it allows for laser curing of the uncured non-thixotropic material before the uncured non-thixotropic material reaches the external surface 209. The present method advantageously allows the uncured non-thixotropic material to be confined within the internal zone 208. This in turn enables the device to be built up by one more layer. In other words, the flow of the material may be impeded by the border 210 for a delay time that is at least longer than a time to at least partially cure the material. The delay time may be at least longer than a time to deposit at least one subsequent layer 250 (FIG. 7) on the layer 220 and to at least partially cure the material.

Curing may be carried out in various ways, including but not limited to laser curing via heat or photochemical effects. Preferably, curing is carried out by heating or photochemically solidifying up the deposited materials using the laser (e.g., laser 321 of FIG. 1). FIG. 5 is a schematic cross-sectional view of one embodiment of the device 200 of FIG. 4A after curing. In this example, the substrate 202 and the deposited layer 220 remain as distinguishable as layers. As one of the results of the laser curing, the layers 220/202 are directly adhered to one another throughout their contacting surfaces without a need for an additional adhesive material interposed between the layers. The substrate 202 may be considered as one layer. That is, in a device 200 with a first layer and a second layer that is deposited immediately adjacent to the first layer, the second layer is preferably deposited prior to a complete curing of the first layer. In the course of curing (e.g., with the aid of the laser 321), polymer chains in the first layer and the second layer form crosslinking bonds such that the first layer and the second layer are strongly bonded or fused together. In some instances, the first layer and the second layer may become indistinguishable from one another, e.g., when the first layer and the second layer are of the same material. Advantageously, conductive elements and other features may be extended from one layer to another without having to deal with an additional adhesive material.

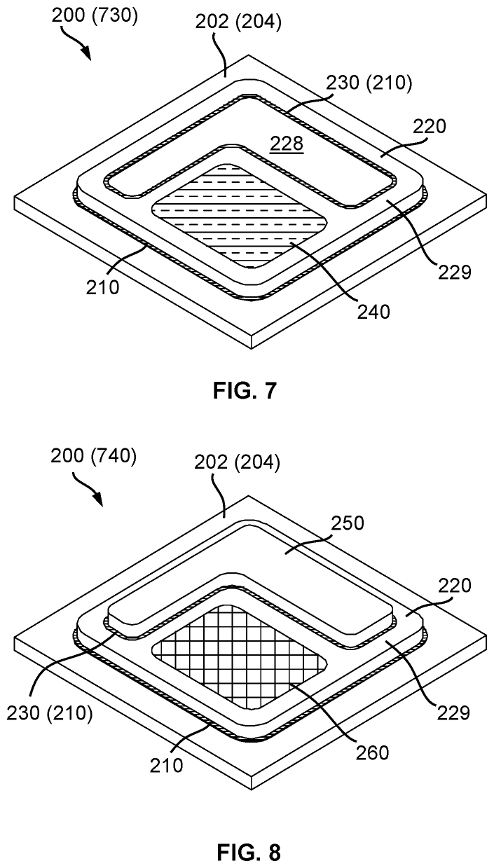

FIG. 6A is a schematic cross-sectional view of another embodiment of the device of FIG. 4A after curing. In the example of FIG. 6A, a later deposited layer is added before an earlier deposited layer is fully cured. On curing, the later deposited layer and the earlier deposited layer adhere or fuse so well together that it is possible obtained an integral product with no distinct layers therein. For example, the substrate 202 may be a partially cured polymer and the deposited material may be of a similar but uncured polymer. Upon laser curing, the partially cured polymer and the uncured polymer are brought to a fully cured state. The resulting device 200 appears as an integral article with no distinguishable layers therein. Advantageously, the resulting device 200 will not have issues traditionally associated with the use of adhesives (e.g., adhesives losing their adhesive properties after prolonged use or under harsh environmental conditions, layers peeling off, etc.) In terms of manufacturability, the present method advantageously integrates curing and adhesion into simultaneously occurring changes effected by the same laser scanning process.

Optionally, the earlier deposited layer may include one or more materials different from the later deposited material. As illustrated in FIG. 6B, in other embodiments, the earlier deposited layer may include elements 240. The deposited material may be provided to encapsulate such elements 240 within the border 210. The elements 240 provided by 3D printing onto the substrate. Alternatively, the elements 240 may be modified from part of the substrate material, e.g., the elements 240 may include porous graphene conductive lines or interconnects formed from a substrate of polyimide during the stage 710 of border formation (or at least before the stage 720 of depositing more materials). As shown in FIG. 6B, the resulting device 200 may be an integral article with the embedded elements 240, in which the earlier layer (or substrate) and the later deposited layer are substantially indistinguishable from one another.

In some embodiments, the border 210 may be configured to impede the flow of a non-thixotropic material from the internal zone 208 to the external zone 209 for a limited duration. For example, the limited duration may be longer than a curing time of the uncured non-thixotropic material. Therefore, the non-thixotropic material may be cured to form the deposition layer 220 without risk of the uncured non-thixotropic material flowing into the external zone 209.

FIG. 7 is a perspective view of the device 200 at subsequent stage 730 of border formation, in which a second border 230 (also referred to as a subsequent border) is drawn on an earlier deposited layer 220. The second border 230 may define a second internal zone 228 (also referred to as a subsequent internal zone) and a second external zone 229 (also referred to as a subsequent external zone), in which the second internal zone 228 and the second external zone 229 are non-overlapping zones spaced apart by the second border 230. In some embodiments, a part of the earlier deposited layer 220 is heated by laser to a second predetermined temperature to form the second border 230, while the internal zone 228 does not undergo surface modification or laser irradiation beyond a partial curing. Preferably, the earlier deposited material in the internal zone 228 is at most partially cured. In order to prevent a premature curing or overly accelerated curing, the second predetermined temperature may be configured below a curing temperature of the uncured non-thixotropic material or the deposition layer 220. The second predetermined temperature is selected as one that is able to effect a microscopic structural change and/or a chemical compositional change to the non-thixotropic material/deposition layer 220 to form the second border 230.

FIG. 8 is a perspective view of the device 200 in a next stage 740 of material deposition. A second material (also referred to as a subsequent material) may be deposited in the second internal zone 228 after the second border 230 is drawn. The second material may be spread or permitted to flow to cover the second internal zone 228. The flow or spreading of the second material beyond the second internal zone 228 is impeded or slowed down by the second border 230. Similar to the border 210 as described above, the second border 230 is configured to impede a flow of an uncured second non-thixotropic material from the second internal zone 228 to the second external zone 229. Preferably, the second border 230 forms a closed path. Further layers of materials and/or borders may be respectively deposited and formed on the device 200 and are not further discussed for sake of brevity. Preferably, in order to facilitate adhesion between the earlier deposited layer 220 and the later deposited layer 250, the deposition of the second material is done when the deposition layer 220 is partially cured, or in other words, prior to complete curing of the deposition layer 220. The second material may be at least partially cured by means of an oven, or preferably by laser curing, to the extent that the second material stops flowing and does not flow into the second external zone 229. In this manner, a second deposition layer 250 is provided within the second border 230.

In some embodiments, the second material is an uncured second non-thixotropic material. In some embodiments, the materials of the earlier deposited layer 220 and the later deposited layer 250 may be dissimilar materials or similar materials. In some examples, both the earlier deposited layer 220 and the later deposited layer 250 include polyimide. In other examples, one of these layers is polyimide (PI) and another of these layers is polydimethylsiloxane (PDMS). In other words, each of the earlier deposited layer 220 and the later deposited layer 250 is selected from the group of non-thixotropic materials, including but not limited to polyimide and polydimethylsiloxane. Advantageously, the present method does not require the material composition of the non-thixotropic materials to be modified (e.g., by mixing in additives, etc.). This avoids the problem of material property changes that increases the viscosity but may negatively impact the suitability of the material (e.g., in terms of conductivity, brittleness, etc.) for use in flexible electronics.

The present method can be implemented to complement other 3D printing techniques. For example, optionally, additional features or surface modification may be provided in either or both of the second internal zone 228 and the second external zone 229. For example, if the bulk of the deposited layer 220 is hydrophobic, one or more elements 240 characterized by a relatively less hydrophobic interface area may be formed using the laser to perform surface modification. In FIG. 7, an exemplary interface area 240 is shown at the external surface 229. In some other examples, the one or more elements 240 may be conductive lines, interconnects, heat sinks, etc. Optionally, the one or more elements 240 may be modified from the earlier deposited layer/material 220. For example, if the earlier deposited material is polyimide, the one or more elements 240 may be porous graphene such that the elements 240 are conductive. In some examples, a hydrophilic material, such as a conductive ink, or other conductive liquid, may be deposited on the non-hydrophobic interface area 240 to form a conductive layer 260 (FIG. 8). Due to the hydrophobic nature of the deposition layer 220, the conductive ink or conductive layer 260 is kept localized on the interface surface 240 without spilling into the deposition layer 220.

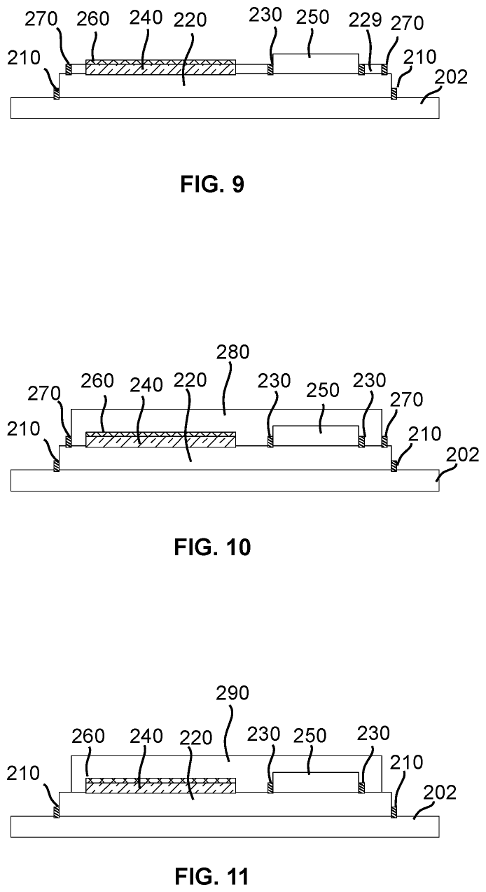

FIGS. 9 and 10 schematically illustrate one embodiment of the method in which a third layer (such as an encapsulation layer) is 3D printed to the device 200 of FIG. 8. For the sake of clarity, some of the features (e.g., borders 210, 270) and the respective height/thickness of the materials/layers are exaggerated in size. A third border 270 may be laser written (FIG. 9). The third border 270 may be created by laser graphitization of a suitable polymer such as polyimide. Alternatively, the third border 270 may be a defined by material modification to a material such as PDMS.

The definition of the third border 270 may be followed by deposition of an uncured third material in the internal zone demarcated by the third border 270 to form an encapsulating layer 280 (FIG. 10). To facilitate interlayer bonding between materials deposited at different times/stages, the deposition of the encapsulating materials may be performed prior to full curing of earlier deposited materials. After the encapsulating materials are deposited, the encapsulating layer 280 and the partially cured earlier deposited layer 220 may be concurrently heated and fully cured.

FIGS. 9 and 11 may alternatively be used to illustrate another embodiment of the present method in which the third layer (such as an encapsulating layer) is 3D printed to the device 200 of FIG. 8. If the material to be deposited is a thixotropic material which can hold its shape upon deposition, the provision of a border may be optional. That is, the thixotropic material may be deposited directly on the top surface of device 200 of FIG. 8 to form an encapsulating layer 290 without the need to first define a border or perimeter for the encapsulating layer 290.

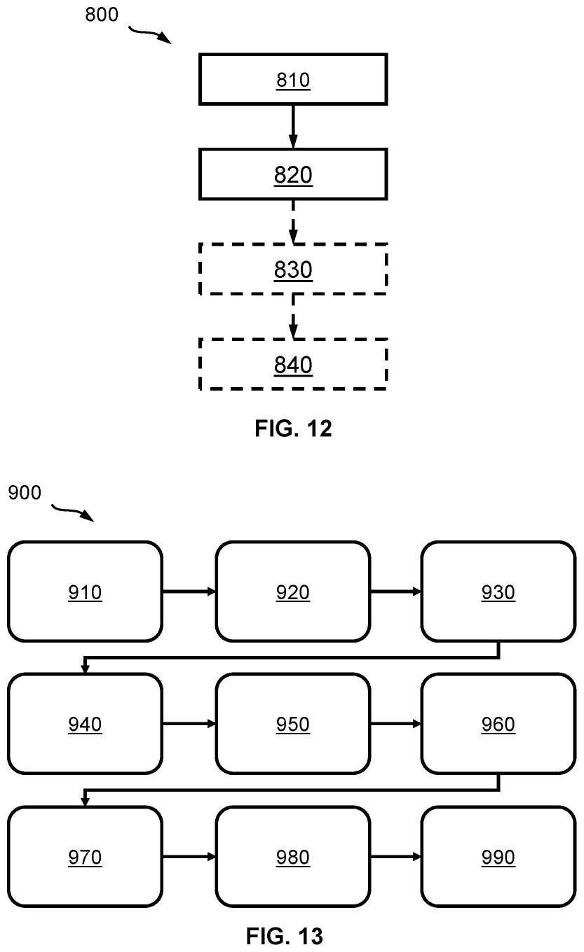

According to another aspect of the disclosure, a hybrid manufacturing method 800 is illustrated in FIG. 12. The method 800 includes directing a laser on a substrate to form a border on a substrate surface (810), in which the border defines on the substrate surface: an internal zone 208 and an external zone 209, with the internal zone 208 and the external zone 209 being non-overlapping. The method 800 includes depositing an uncured non-thixotropic material in the internal zone 208 to form a deposition layer within the border (820), in which the border on the substrate is configured to impede a flow of the uncured non-thixotropic material from the internal zone 208 to the external zone 209. Optionally, in some embodiments, the method 800 includes directing the laser on the deposition layer to at least partially cure the uncured non-thixotropic material of the deposition layer (830). Optionally, in some embodiments, the method includes directing the laser on the deposition layer to form an interface surface on the deposition layer (840).

FIG. 13 is a flow diagram schematically illustrating a method 900 of fabricating soft carbon electronics devices according one embodiment of the present disclosure. In actual applications, the sequence of the various steps, the number of steps, the materials selected, the laser parameters chosen, etc., may differ according to target configuration for the device.

A porous graphene border may be written into a substrate (910). The substrate may be polyimide printing substrate or any other substrate which can undergo graphitization by laser treatment. The porous graphene border may be written in any shape required by the application. Preferably, the porous graphene border defines a closed loop or a closed perimeter. The porous graphene border may be configured such that a flow of a deposited uncured soft elastomer is arrested or stopped at the border for as much as about ten minutes. This delay period of about 10 minutes is selected to allow time for the curing and printing of subsequent layers. For other materials, the delay period may differ.

A porous graphene component that provides active functionality can then be written into the printing substrate (920). The porous graphene component may be written in any shape and size required by the intended application.

Unmodified and uncured soft elastomer is deposited via the materials dispenser within the border, e.g., in the internal space defined within the border (930). Overflowing of the soft elastomer (beyond the border) is arrested or impeded by the porous graphene border, forming a layer of the soft elastomer in the desired shape and layer thickness (height).

The same laser used to form the porous graphene border and the porous graphene component may be used to promote curing of the deposited elastomer via heat or any other curing mechanism (940). The deposited soft elastomer substrate may be partially cured to enhance interlayer bonding with subsequently deposited elastomer layers (subsequent elastomer layers).

The required number of subsequent elastomer layers may be deposited and cured in the same manner. Similarly, the required number of subsequent borders may be written into the subsequent elastomer layers. For subsequent elastomer layers where border formation by laser graphitization is not possible (such as PDMS substrates), a material modified border may be written. The subsequent borders may be written in any shape and dimensions and used for controlling or impeding or redirecting the flow or spread of deposited materials as described above.

For example, the border may be configured such that the flow of the deposited uncured soft subsequent elastomer (for one layer) is stopped or impeded at the border for at least about ten minutes or for a period of time sufficient for the curing and printing of subsequent layers. Ten minutes is given as a non-limiting example.

Optionally, an interface area may be written into the soft elastic layer using the same laser (950). The interface area may be an area of laser-fabricated porous graphene on the receiving surface of the elastomer. The interface area may be configured to promote adhesion between hydrophilic inks and hydrophobic elastomer materials.

Uncured conductive ink may be deposited using a similar materials dispenser (960). The uncured conductive ink may be deposited on the interface area.

The conductive ink may then be cured using the same laser (970).

Unmodified and uncured soft elastomer may be deposited via a materials dispenser to encapsulate the cured ink (980).

The encapsulation layer may be fully cured along with the rest of the earlier deposited layers using the laser (990). A fully soft graphene device can thus be formed.

As described, the method proposed herein can be applied to manufacture integrated or embedded carbon electronics and/or soft electronics. The fabrication of the carbon electronics may be done via an integrated process, such as an integrated fabrication of carbon electronics elements, elastomeric substrates, and other functional components such as silver ink traces. Further, the system and method allow for use of conventionally non-3D printable soft materials in the additive manufacturing process through flow control borders, hence alleviating the need for on-the-spot curing or material modification. Further, an improved material interface between hydrophobic substrates and hydrophilic inks may be provided by forming interface surfaces, such as porous graphene or other surface modifications, without the need for conventional plasma treatments.

The device 200 may advantageously be formed as a flexible and stretchable article. Advantageously, the present method of additively manufacture can fabricate the device 200 as a plurality of layers in adhesion or an integral article in which the plurality of layers are well bonded together, in which the device 200 can include a diversity of dissimilar elastic/resilient materials. For example, as a part of the device 200, a plurality of non-thixotropic material layers may be produced in adhesion to one another. In some embodiments, the device 200 may include least one conductive line or conductive track disposed between two adjacent ones of the plurality of non-thixotropic material layers. Further, in some embodiments, the device 200 may include at least one layer of conductive ink disposed between two adjacent ones of the plurality of non-thixotropic material layers. The system 100 enables the device 200 to be produced by way of additive manufacturing, instead of being limited to conventional manufacturing methods such as forming or by molding. This allows for free-form multi-layer fabrication of soft electronics devices without the need for molds, which further allows the formation of vias and such features.

Advantageously, according to some embodiments, the substrate 202 may be a polyimide (PI) substrate and the border 210 may be of porous graphene. In addition to impeding a material flow across the border 210, the same porous graphene material may be formed as elements 240 between deposited layers to act as an electrical conductor/conducting line for the devices. As an example, a conductive porous graphene element 240 may be disposed in contact pressure sensitive materials to form a pressure sensor. As another example, conductive porous graphene element 240 may be configured as heating element for wearable devices in allowing localized hearing/warming, therefore, the same porous graphene material formed for the border 210 may be an electrical conductor when formed as an element 240 and the substrate 202 may be an electrical insulator. For example, at least one portion of one layer may include a modified material, in which the modified material includes one or both of a hydrophobic and/or oleophobic material and a material compositionally different from the first layer, and in which the modified material is part of at least one element and/or the border on the layer.

All examples described herein, whether of apparatus, methods, materials, or products, are presented for the purpose of illustration and to aid understanding and are not intended to be limiting or exhaustive. Various changes and modifications may be made by one of ordinary skill in the art without departing from the scope of the invention as claimed.

1. A hybrid manufacturing method, the method comprising:
laser writing a border on a receiving surface of a substrate, the border defining an internal zone inside the border and an external zone outside the border, the border being a part of the substrate that is changed in its material properties by the laser writing;
depositing a material in the internal zone, the material being deposited in an uncured state on the receiving surface, wherein a flow of the material from the internal zone towards the external zone is impeded by the border; and
at least partially curing the material in the internal zone, the at least partially cured material forming a layer.

2. The method as recited in claim 1, wherein the border defines a perimeter of the layer.

3. The method as recited in claim 1, wherein the border comprises an impeding surface on the receiving surface, and wherein the flow of the material across the impeding surface is slower than the flow of the material across the substrate.

4. The method as recited in claim 1, wherein the flow of the material is impeded by the border for a delay time that is at least longer than a time to at least partially cure the material.

5. The method as recited in claim 4, wherein the delay time is at least longer than a time to deposit at least one subsequent layer on the layer and to at least partially cure the material.

6. The method as recited in claim 1, wherein the border is embedded in the substrate.

7. The method as recited in claim 1, wherein the substrate comprises polyimide, and wherein the laser writing comprises forming laser-induced porous graphene as the border.

8. The method as recited in claim 1, wherein the material comprises polyimide.

9. The method as recited in claim 1, wherein the material comprises a non-thixotropic material.

10. The method as recited in claim 1, wherein the material comprises polydimethylsiloxane.

11. The method as recited in claim 1, wherein the border is oleophobic.

12. The method as recited in claim 1, further comprising:
using laser heating to form an interface area on the layer, the layer being hydrophobic, the interface area being non-hydrophobic properties; and
depositing a hydrophilic material on the interface area.

13. The method as recited in claim 12, wherein the hydrophilic material comprises a conductive ink.

14. The method as recited in claim 1, further comprising:
laser writing a subsequent border on the layer to define a subsequent internal zone; and
depositing a subsequent material on the layer prior to a complete curing of the layer, the subsequent material being deposited in the subsequent internal zone to form a subsequent layer.

15. The method as recited in claim 14, the method further comprising:
laser writing a third border on the subsequent layer; and
prior to a complete curing of the subsequent layer, depositing an uncured third material to form an encapsulating layer, wherein the encapsulating layer has a perimeter defined by the third border.

16. The method as recited in claim 15 to fabricate a device with a first layer and a second layer, the method further comprising: depositing the second layer immediately adjacent to the first layer prior to a complete curing of the first layer, wherein the second layer is one of the subsequent layer and the encapsulating layer, and wherein the first layer is correspondingly one of the layer and the subsequent layer.

17. The method as recited in claim 16, further comprising embedding at least one element between the first layer and the second layer.

18. The method as recited in claim 16, wherein at least one of the first layer and the second layer comprises a non-thixotropic material.

19. The method as recited in claim 17, wherein at least one portion of the first layer comprises a modified material, the modified material comprising one or both of a hydrophobic and/or oleophobic material and a material compositionally different from the first layer, and wherein the modified material is part of the at least one element and/or the border.

20. The method as recited in claim 16, and wherein the first layer and the second layer are in crosslinking bond with one another such that the first layer and the second layer are indistinguishable from one another.
